(19) United States
(12) Patent Application Publication
(10) Pub. No.: US 2008/0130094 A1
(43) Pub. Date: Jun. 5, 2008

(54) Solid state optical scanners based on electro-optic graded index

(75) Inventor: Suning Tang, Fremont, CA (US)

Correspondence Address: Bo-In Lin, 13445 Mandoli Drive, Los Altos Hills, CA, 94022, US

(73) Assignee: Crystal Research, Inc.

(21) Appl. No.: 11/633,367

(22) Filed: Dec. 4, 2006

(51) Int. Cl. G02F 1/29

(52) U.S. Cl. 359/315

(57) ABSTRACT

An electro-optical scanner includes an optical transparent crystal. The electro-optical scanner further includes an electrode for applying a voltage on the optical transparent crystal for applying an electric field therein for generating a graded electro-optic effect in the transparent crystal for deflecting an optical beam projected therethrough. The electro-optical scanner further includes a voltage controller for controlling the voltage applied to the optical transparent crystal for controlling the optical beam with a controlled deflecting angle projected through the optical transparent crystal.

### TECHNICAL FIELD

This invention relates to the control of optical beam implemented typically in an optical scanner. More particularly, this invention relates to a solid-state optical scanner that is based on techniques of controlling and changing the electro-optic graded index.

### BACKGROUND ART

Current beam steering systems are very complex, costly, and too large for most applications due to the required space for placement of the steering systems. Devices for controlling the direction of an optical beam have been limited in the past, and confined almost entirely to such methods as galvanic mirrors. The optical steering systems that implement these methods have been limited by various problems including scanning speed, driving power, and resolution of beam control. Furthermore, as such systems include more controlling and moving parts. More complex and costly fabrication and assembling processes are involved.

Several device concepts for electro-optic deflectors have been reported that includes the disclosures of V. J. Fowler and J. Schlafer, “A survey of laser beam deflection techniques,” (Applied Optics, vol. 5, pp. 1675-1682, 1966); R. A. Meyer, “Optical beam steering using a multichannel Lithium Tantalate crystal,” (Applied Optics, vol. 11, pp. 613-616, 1972); Y. Ninomiya, “Ultrahigh resolving electro-optic prism array light deflectors,” (IEEE J. Quantum Electron., vol. QE-9, pp. 791-795, 1973); J. F. Revelli, “High-resolution electro-optic surface prism waveguide deflector: an analysis,” (Appl. Optics, vol. 19, pp. 389-397, 1980); Yi Chiu, V. Gopalan, M. J. Kawas, T. E. Schesinger, Daniel D. Stancil, and W. P. Risk, “Integrated optical device with electrooptic lens and electrooptic scanner in LiTaO3,” (IEEE J. Lightwave. Technol., vol. 17, pp. 462465, 1999); David A. Scrymgeour, Yaniv Barad, Venkatraman Gopalan, Kevin T. Gahagan, Quanxi Jia, Terence E. Mitchell, and Jeanne M. Robinson, “Large-angle electro-optic laser scanner on LiTaO3 fabricated by in situ monitoring of ferroelectric-domain micro-patterning,” (Appl. Opt., vol. 40, no. 30, pp. 6236-6241, 2001); and Lin Sun, Jinha Kim, Jeffery Maki, and Suning Tang, “Polymeric waveguide prism-based electro-optic beam deflector,” ( Opt. Eng. vol., 40, no. 7, pp. 1217-1222, 2001). Devices using bulk crystals as that disclosed by Fowler et al. are generally larger, heavier, and require higher driving voltages (usually kV). More compact devices with lower operating voltages can be realized using metallic electrodes on electro-optic wave-guides as disclosed in some of the above-listed publications. However, all the existing devices are confronted by the intrinsic limitations such as small deflection angle, low steering speed and high driving voltage. The technical development demonstrated so far, in general, adds to device complexity and/or imposes extremely difficult operating processes.

As disclosed in above publications, the electro-optic EO beam scanners in general have attractive features such as high-speed response and capability of digital/analog scanning with fine angular resolution. But a drawback of the conventional electro-optic beam scanners is that even a small scanning angle requires a high voltage. Such limitation is still not resolved by the systems as described in the above published disclosures.

Therefore, there still exists a need in the art of optical beam scanning systems to provide new and improved techniques to control-the beam and a device configuration to implement the beam control such that the above-discussed technical difficulties and limitations may be resolved.

### SUMMARY OF THE INVENTION

One aspect of this invention is to use optical transparent crystals that composed of materials with graded electro-optic effect. The material of the graded electro-optic effect has a characteristic that the electro-optic coefficient varies gradually or step-by-step along the direction of applied electric field. As a result, the electro-optic index modulation changes gradually or step-by-step inside the crystal under applied electric field.

Another aspect of this invention is to implement an optical beam control by applying an electric signal to an electro-optic crystal composed of a material that has graded electro-optic effect to provide high-speed, wide-angle beam scanning using low driving voltage such that the above-discussed difficulties and limitations can be overcome.

Another aspect of this invention is to implement an optical beam control by applying an electric signal to an electro-optic crystal composed of material that has graded electro-optic effect to control the scanning of an optical beam such that the scanner can be manufactured with significantly simplified configuration with much smaller size. Compact optical scanners can be manufactured with greatly reduced cost for broader varieties of applications.

Another aspect of this invention is to implement an optical beam control by applying an electric signal to an electro-optic crystal composed of material that has graded electro-optic effect to control the scanning of an optical beam such that an optical beam can be scanned without using any moving components.

These and other objects and advantages of the present invention will no doubt become obvious to those of ordinary skill in the art after having read the following detailed description of the preferred embodiment, which is illustrated in the various drawing figures.

### BRIEF DESCRIPTION OF DRAWINGS

FIGS. 1A to 1C illustrate the operational principles of the optical beam scanner implemented in a composition uniform crystal composed of materials with graded electro-optic effect.

FIGS. 2A to 2B illustrate the operation principle of the optical beam scanner based on composition graded crystals composed with material that has graded electro-optic effect wherein the graded composition results in a graded index distribution to create an angular offset for the optical beam at the output end of the beam scanner.

FIG. 3 illustrates the schematic diagram of an electro-optic beam scanner.

FIG. 4 illustrates the schematic diagram of optical beam scanner using a prism like output surface. The prism like structure increases the scanning angle compared to the tetragonal structure shown in FIG. 3.

FIG. 5 is a functional block diagram for illustrating an electro-optic beam scanning system implemented with graded electro-optic effect in an optical transparent crystal.

### DETAILED DESCRIPTION OF THE PREFERRED EMBODIMENTS

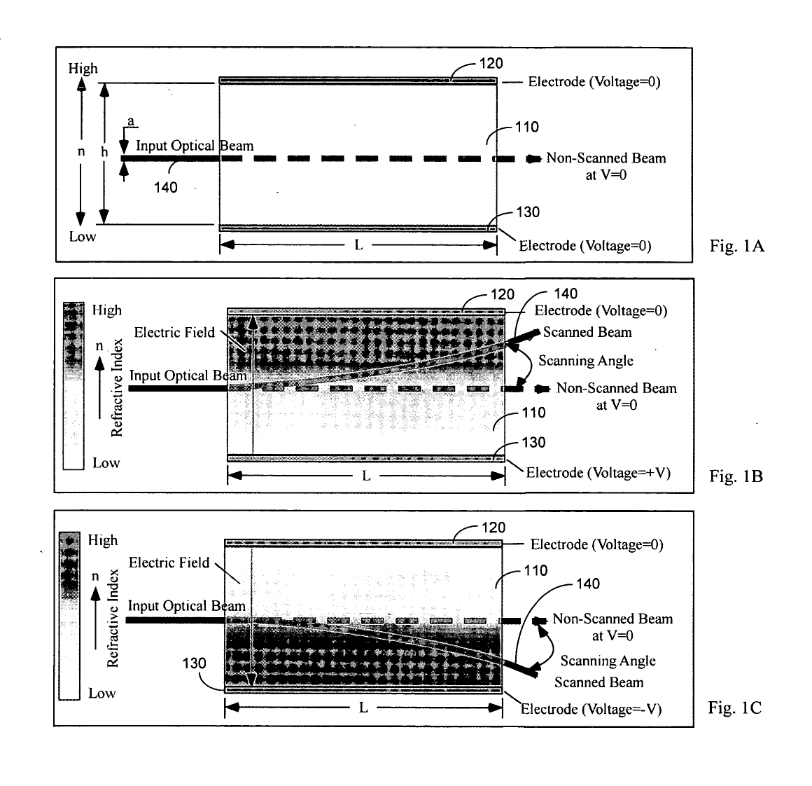

The graded electro-optic effect: the electro-optic coefficient varies gradually or step-by-step along the direction of applied electric field in an optical transparent crystal. As a result, the electro-optic index modulation changes gradually or step-by-step inside the crystal under applied electric field. Referring to FIGS. 1A to 1C for diagrams that illustrate one of the operation principles of the optical beam scanner based on graded electro-optic effect in a uniform optical transparent crystal. As shown in FIG. 1A, the optical beam scanner is formed with an optical transparent crystal 110 with graded electro-optic effect. (As an example, the crystal can be composed of materials such as KTa₁₋ₓNbₓO₃, K_{1-y}L_{y}Ta₁₋ₓNbₓO₃, and Sr₁₋ₓBaₓNb₂O₆). The crystal 110 is further coated with a top and bottom electrodes 120 and 130 respectively. The beam control is based on graded electro-optic effect in the electro-optic crystal 110. When an electric filed is applied to these crystals, it creates a large spatial gradient of refractive index inside the crystal 110. As a result, an optical beam 140 that propagates through is deflected between the electrodes 120 and 130 deposited on the surfaces of crystal as that shown in FIGS. 1B and 1C. In other words, the applied electric field induces a gradation of refractive index inside the electro-optic crystal 110 and the optical beam 140 propagating through the crystal is continuously and cumulatively deflected. Both digital and analog scanning can be electrically controlled through electro-optic effect without using any moving components.

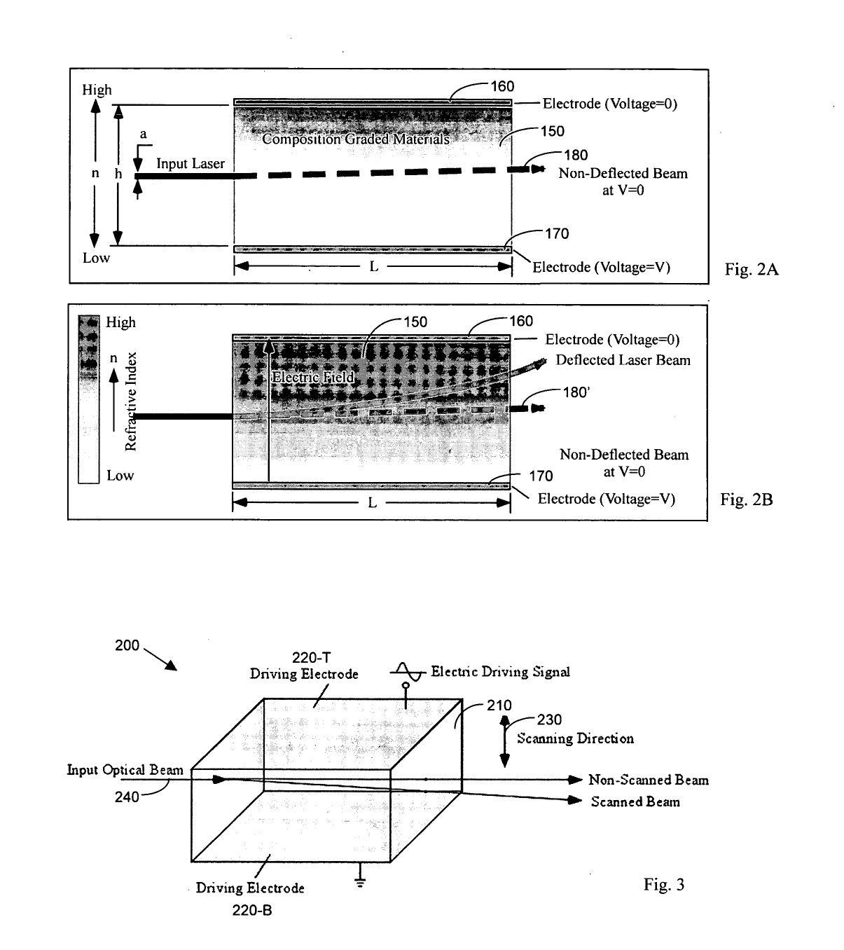

FIGS. 2A and 2B illustrate the operation principle of the optical beam scanner based on composition graded crystals where the crystal composition gradient gives rise to a graded electro-optic effect. The graded electro-optic effect is realized in an electro-optic crystal 150. The electro-optic crystal 150 has a graded composition of an electro-optic crystal along the driving electric field direction, i.e., along a direction between the top and bottom electrodes 160 and 170 respectively. The variation crystal composition results in the change of electro-optic coefficient in the crystal. When electric field is applied, it gives rise to a graded electro-optic index distribution that deflects light beam propagation as that shown in the deflected laser beams 180′ from an original projection path 180.

The novel phenomenon in which optical beam is steered by simply applying an electrical signal to an electro-optic crystal, e.g., KTa₁₋ₓNbₓO₃, K_{1-y}L_{y}Ta₁₋ₓNbₓO₃, and Sr₁₋ₓBaₓNb₂O₆, etc., enables the development of optical beam scanner with wide scanning angle, high-speed response, low driving voltage and compactness. The optical beam scanner of this invention can therefore overcome problems of conventional scanners and enables breakthrough performance of over >15° scanning angle and fast driving speed (>100 kHz).

The electro-optic beam scanner as disclosed in this invention is advantageous whenever there is a need for fast optical beam steering with a large scanning angle and low driving voltage. It is noted that the scanners based on the electro-optic beam control have not been broadly applied due to the fact that a non-mechanical optical beam deflector has not been practically demonstrated yet. This invention demonstrates a reliable electro-optic scanner with large deflection angle, low driving voltage, and fast slew rate. The scanner is also lightweight and manufactured with simplified fabrication scheme and can be packaged into a housing container with a compact structure. The electro-optic based scanners as disclosed in this invention thus enables wide commercial applications in laser radar, fiber optic communication, optical mass storage and other far reaching applications

FIG. 3 shows the schematic diagram of an optical beam scanner 200 in a single KTa₁₋ₓNbₓO₃ crystal 210 to achieve one-axis optical beam scanning. The one-dimensional optical beam scanning is achieved by driving the pair of electrodes. The pair of electrodes includes a top and bottom electrodes 220-T and 220-B respectively. The pair of electrodes creates an electric field when an electrical voltage is applied. The graded electro-optic effect gives rises to graded index distribution along the applied electric field. Thus it causes the optical beam 240 to deflect according to the applied electric field. The deflection direction 230 changes when the direction of electric field changes. The deflection angle changes with the change of driving voltage.

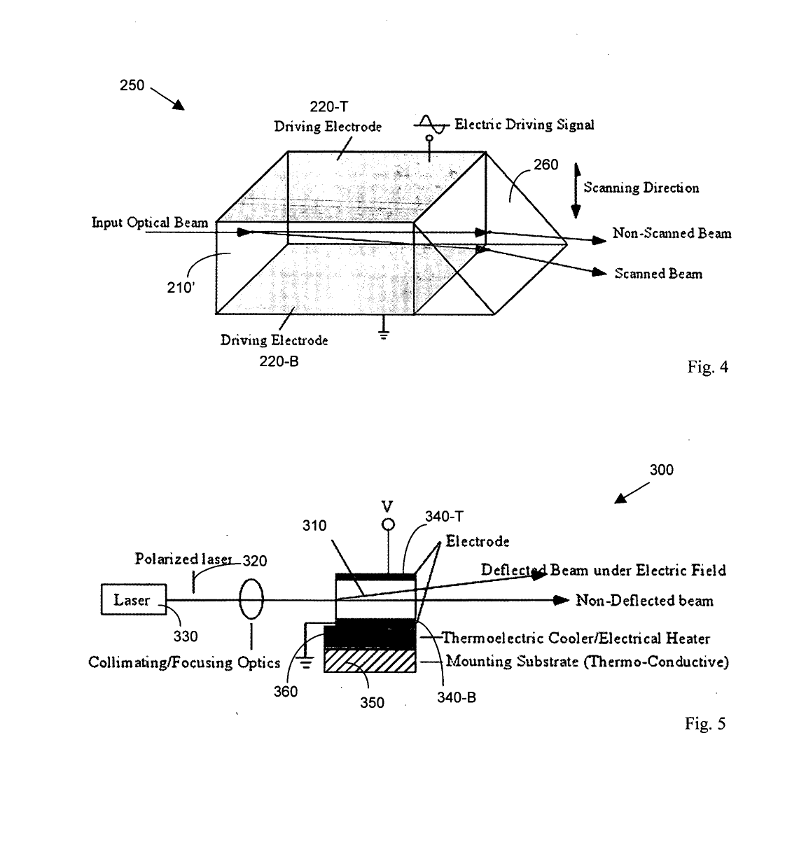

FIG. 4 illustrates the schematic diagram of an optical beam scanner 250 using a prism like output surface 260. The prism like structure increases the scanning angle compared to the tetragonal structure shown in FIG. 3.

FIG. 5 shows the functional diagram for illustrating an electro-optic scanner 300 implemented in an optical transparent crystal 310 with graded electro-optic effect. A polarized laser beam 320 is projected from a laser source 330 through the optical transparent crystal 310 with graded electro-optic effect. The top and bottom surfaces of the transparent crystal 310 are coated with electrodes 340-T and 340-B respectively to apply an electric voltage to the electrodes. The transparent crystal 310 is mounted on a thermal conductive substrate that is connected with a temperature controlling device 360 such as a thermoelectric cooler/heater. The temperature controlling device 360 heats or cools the transparent crystal to maintain a stable operating temperature.

Specifically, the one-dimensional beam control process can be summarized as the following four steps: 1) graded index is formed under applied electric field based on graded electro-optic effect. 2) The magnitude of the index modulation is a function of the magnitude of applied electric field. 3) The spatial electro-optic index variation causes the optical beam deflection; and 4) continuous and cumulative large angle deflection throughout the optical wave propagation along the crystal.

The graded electro-optic effect is applicable to many electro-optic crystals, such as KTa₁₋ₓNbₓO₃, K_{1-y}L_{y}Ta₁₋ₓNbₓO₃ and Sr₁₋ₓBaₓNb₂O₆ crystals. An optical beam scanner similar to that shown in FIG. 3 can be realized in other electro-optic crystals as well and the specific embodiment as disclosed should not be interpreted as limiting in terms of the electro-optic crystals or structural features as disclosed in these specific embodiments.

The deflection angle achievable in the electro-optic crystals based on graded electro-optic effect may be expressed by

$$θ = \frac{Δ n ( E )}{n} \frac{L}{a} , \qquad ( 1 )$$

where L the crystal length, h is the crystal thickness, and a is the optical beam width as shown in FIG. 5. n is the refractive index of crystal, and Δn(E) is the refractive index modulation induced by electric field (E=V/h) cross the optical beam, and the V is the applied voltage.

There are three methods to increase the deflection angle: 1) employing longer crystal length, which accumulates the deflection angles while reducing the driving voltage; 2) decreasing crystal thickness, which increases the electric field for a fixed driving voltage; and 3) optimizing crystal composition to provide larger index modulation of Δn(E).

The common difficulties as encountered in the conventional Electro-optic EO beam scanners due to the requirement of a high voltage to even deflect a small angle is therefore resolved. The electro-optic scanner as disclosed in this invention has overcome this problem and overcome the limitation of a low driving efficiency by increasing a scanning angle to driving field ratio by approximately one-hundred times. Moreover, comparing to the moving mirrors such as the polygon mirrors and galvanic mirrors as widely used in laser printers, photocopiers and so on, the KTa₁₋ₓNbₓO₃ scanner disclosed in this invention now provides an improved response time that is at least one-hundred time faster while reduce the volume of the scanner to only about one-tenth of these conventional scanners. With the improved performance, the scanners of this invention as that implemented with the KTa₁₋ₓNbₓO₃ crystals are expected to expand the application fields not only in laser radars, printings, imaging, displays, and so on with its unprecedented high performance.

The ultra large graded electro-optic effect-provides a driving efficiency 100 times larger than that of any existing electro-optic beam scanners. Compared to moving mirrors such as polygon mirrors and galvanic mirrors, the beam scanner of this invention further improves the response time by 100 times and reduce the device volume by factor of 10 while achieving a comparable scanning angle. Further more, the beam scanner of this invention has many other improved features such as lightweight, low power consumption, and no-moving components in a simplest device configuration. A new and improved electro-optic beam scanner is therefore disclosed.

This invention thus discloses a non-mechanical optical beam scanner based on graded electro-optic effect. A reliable electro-optic scanner with large deflection angle at low driving voltage, fast slew rate, light weight, simplified fabrication scheme, and compact structure would find wide commercial applications in laser radar, fiber optic communication, optical mass storage and other far reaching applications.

Although the present invention has been described in terms of the presently preferred embodiment, it is to be understood that such disclosure is not to be interpreted as limiting. Various alterations and modifications will no doubt become apparent to those skilled in the art after reading the above disclosure. Accordingly, it is intended that the appended claims be interpreted as covering all alterations and modifications as fall within the true spirit and scope of the invention.

I claim:

1. An electro-optical scanner comprising:
an optical transparent crystal; and a pair of electrodes for
for applying a voltage on said optical transparent crystal for creating an electric field for generating a graded electro-optic effect in said transparent crystal for deflecting an optical beam projected therethrough.

2. The electro-optical scanner of claim 1 further comprising:
a voltage controller for controlling said voltage applied to said optical transparent crystal for controlling said optical beam with a controlled deflecting angle projected therethrough.

3. The electro-optical scanner of claim 1 wherein:
said electrode further comprising a high voltage electrode formed as a first conductive layer on a first side surface of said optical transparent crystal; and
said electrode further comprising a low voltage electrode formed as a second conductive layer on a second side surface of said optical transparent crystal opposite said first side surface.

4. The electro-optical scanner of claim 1 wherein:
said optical transparent crystal is composed of a KTa₁₋ₓNbₓO₃ material.

5. The electro-optical scanner of claim 1 wherein:
said optical transparent crystal is composed of a K_{1-y}L_{y}Ta_{1-y}NbₓO₃ material.

6. The electro-optical scanner of claim 1 wherein:
said optical transparent crystal is composed of a Sr₁₋ₓBaₓNb₂O₆ material.

7. The electro-optical scanner of claim 1 wherein:
said optical transparent crystal is composed of an ion doped KTa₁₋ₓNbₓO₃, K_{1-y}L_{y}Ta₁₋ₓNbₓO₃ material.

8. The electro-optical scanner of claim 1 wherein:
said optical transparent crystal is composed of an ion doped Sr₁₋ₓBaₓNb₂O₆ material.

9. The electro-optical scanner of claim 1 wherein:
said optical transparent crystal is composed of said electro-optic effect with an electro-optic coefficient varies gradually along a direction of said voltage applied on said optical transparent crystal.

10. The electro-optical scanner of claim 1 wherein:
said optical transparent crystal is composed of said electro-optic effect with an electro-optic coefficient varies in a stepwise manner along a direction of said voltage applied on said optical transparent crystal.

11. The electro-optical scanner of claim 1 further comprising:
a digital voltage controller for digitally controlling said voltage applied to said optical transparent crystal for controlling said optical beam with a controlled deflecting angle projected therethrough.

12. The electro-optical scanner of claim 1 further comprising:
an analog voltage controller for receiving an analog control signal for controlling said voltage applied to said optical transparent crystal for controlling said optical beam with a controlled deflecting angle projected therethrough.

13. The electro-optical scanner of claim 1 wherein:
said optical transparent crystal is composed of material with an uniform composition with said electro-optic effect.

14. The electro-optical scanner of claim 1 wherein:
said optical transparent crystal is composed of material with a non-uniform composition with said electro-optic effect.

15. The electro-optical scanner of claim 1 wherein:
said optical transparent crystal is composed of material with a graded composition with said electro-optic effect.

16. The electro-optical scanner of claim 1 wherein:
said optical transparent crystal is composed of a material with said electro-optic effect dependent on a temperature.

17. The electro-optical scanner of claim 1 wherein:
said optical transparent crystal further comprising a tilt-side surface for increasing a deflecting angle of said optical beam projected through said optical transparent crystal.

18. The electro-optical scanner of claim 1 wherein:
said optical transparent crystal is composed of material with said electro-optic effect dependent on a temperature.

19. The electro-optical scanner of claim 1 wherein:
said electrode further comprising a first set of electrodes for applying a voltage along a first direction in said optical transparent direction for deflecting said optical beam along said first direction and a set sets of electrodes for applying a voltage along a second direction for deflecting said optical beam along said second direction whereby said optical beam projected through said optical transparent crystal is controllable to deflect in at least two directions.

20. The electro-optical scanner of claim 1 wherein:
said optical transparent crystal is composed of a Cu+ ion doped KTa₁₋ₓNbₓO₃, K_{1-y}L_{y}Ta₁₋ₓNbₓO₃ material.

21. The electro-optical scanner of claim 1 wherein:
said optical transparent crystal is composed of a Cu+ ion doped Sr₁₋ₓBaₓNb₂O₆ material.

22. An electro-optical scanner comprising:
an optical transparent crystal composed of a material with an electro-optical effect dependent on a temperature of said optical transparent crystal.

23. A method for controlling an optical beam projected through a beam controlling apparatus comprising:
applying a voltage on an optical transparent crystal for creating an electric field that generates a graded electro-optic effect in said transparent crystal for controlling a deflection angle an optical beam projected through said optical transparent crystal.

24. A method for controlling an optical beam projected through a beam controlling apparatus comprising:
applying a graded temperature profile on an optical transparent crystal having a graded electro-optic effect dependent on said graded temperature profile in said transparent crystal for controlling a deflection angle an optical beam projected through said optical transparent crystal.
